(19) United States
(12) Patent Application Publication
(10) Pub. No.: US 2022/0308794 A1
(43) Pub. Date: Sep. 29, 2022

(54) DISTRIBUTED STORAGE SYSTEM AND MANAGEMENT METHOD

(71) Applicant: Hitachi, Ltd., Tokyo (JP)

(72) Inventors: Takayuki FUKATANI, Tokyo (JP); Mitsuo HAYASAKA, Tokyo (JP)

(73) Assignee: Hitachi, Ltd., Tokyo (JP)

(21) Appl. No.: 17/474,337

(22) Filed: Sep. 14, 2021

(30) Foreign Application Priority Data
Mar. 26, 2021 (JP) 2021-053791

(51) Int. Cl. G06F 3/06

(52) U.S. Cl. CPC G06F 3/0659; G06F 3/0665; G06F 3/0611; G06F 3/067

(57) ABSTRACT

In a distributed storage system including a plurality of distributed FS servers, a distributed volume, and a management server, the distributed volume is configured by a plurality of LUs, the distributed FS server that manages each LU is determined, the LU that stores a file is determined based on a hash value of the file, the distributed FS server that manages the determined LU executes I/O processing on the file of the distributed volume, and when changing the distributed FS server that manages the LU, a CPU of the management server reflects, in the distributed FS server, a correspondence relationship between the LU after the change and the distributed FS server that manages the LU.

### BACKGROUND OF THE INVENTION

### 1. Field of the Invention

The present invention relates to a technology for rebalancing data among a plurality of servers in a distributed storage system including the plurality of servers.

### 2. Description of the Related Art

As a storage destination of large-capacity data for artificial intelligence (AI)/big data analysis, a scale-out distributed storage system capable of expanding capacity and performance at low cost has been widely used.

In a storage for a data lake used as a backend of a large number of users and services, scale-out at the time of performance or capacity shortage, and scale-in at the time of resource surplus for energy saving are required.

On the other hand, with an increase in data to be stored in a storage, a storage data capacity per node (server) also increases, a data rebalancing time at the time of increasing or decreasing the number of servers becomes long, and an influence on performance of access from a client becomes a problem.

For example, US 2016/0349993 A discloses a technology in which a data locationis dynamically calculated from a hash value of data in a distributed storage including a large number of servers, thereby eliminating the need for metadata server access at the time of data access. According to the technology of US 2016/0349993 A, since a performance bottleneck of the metadata server is eliminated, performance scalability proportional to the number of servers can be realized.

### SUMMARY OF THE INVENTION

As in the technology disclosed in US 2016/0349993 A, in a distributed file system in which data are arranged in a distributed manner by using a hash value of data, the hash value is calculated from an identifier of the data by using a hash function, and the data location is determined so that data amounts are equal between servers. Here, the hash function indicates a function that outputs a random value as a hash value for one or more inputs. Therefore, in a case where a server configuration is changed due to the increase or decrease of the number of servers, a range of the hash value of the data stored in each server is also changed, and data rebalancing between the servers is required.

As described above, in a case where the range of the hash value of the data stored in each server is changed due to the increase or decrease of the number of servers, migration of a large amount of data occurs. The amount of data to be migrated depends on a hash calculation method, but at least data stored in one server is to be migrated between servers. Due to the recent increase in device capacity, the data capacity per server has increased, and data migration may require several days to several weeks.

In addition, in the data migration between the servers, data transfer between the servers via a network is required. In the distributed file system, since a network resource is shared by processing for data access from a client and rebalancing processing, an influence on performance of access from a client becomes a problem.

The present invention has been made in view of the above circumstances, and an object of the present invention is to provide a technology capable of efficiently rebalancing data among a plurality of servers in a distributed storage system.

In order to achieve the object described above, an aspect of the present invention provides a distributed storage system including: a plurality of distributed servers; a shared storage area accessible by the plurality of distributed servers; and a management apparatus, in which the shared storage area is configured by a plurality of logical unit areas, the distributed server that manages each of the logical unit areas is determined, the logical unit area that stores a data unit is determined based on a hash value for the data unit, the distributed server that manages the determined logical unit area executes I/O processing on the data unit of the shared storage area, and when changing the distributed server that manages the logical unit area, a processor of the management apparatus reflects, in the distributed server, a correspondence relationship between the logical unit area after the change and the distributed server that manages the logical unit area.

According to the present invention, it is possible to efficiently rebalance data among the plurality of servers in the distributed storage system.

### BRIEF DESCRIPTION OF THE DRAWINGS

FIG. 1 is a diagram illustrating an outline of processing executed by a distributed storage system according to a first embodiment;

FIG. 2 is a configuration diagram of the distributed storage system according to the first embodiment;

FIG. 3 is a configuration diagram of a distributed FS (file system) server according to the first embodiment;

FIG. 4 is a configuration diagram of a distributed volume configuration management table according to the first embodiment;

FIG. 5 is a configuration diagram of a server statistical information table according to the first embodiment;

FIG. 6 is a configuration diagram of a storage array according to the first embodiment;

FIG. 7 is a configuration diagram of an LU control table according to the first embodiment;

FIG. 8 is a configuration diagram of a LU statistical information table according to the first embodiment;

FIG. 9 is a configuration diagram of a management server according to the first embodiment;

FIG. 10 is a configuration diagram of a distributed volume management table according to the first embodiment;

FIG. 11 is a configuration diagram of a server management table according to the first embodiment;

FIG. 12 is a configuration diagram of an array management table according to the first embodiment;

FIG. 13 is a configuration diagram of an LU allocation management table according to the first embodiment;

FIG. 14 is a configuration diagram of a client server according to the first embodiment;

FIG. 15 is a configuration diagram of a hash management table according to the first embodiment;

FIG. 16 is a diagram illustrating an outline of data storage processing in the distributed storage system according to the first embodiment;

FIG. 17 is a flowchart of volume creation processing according to the first embodiment;

FIG. 18 is a flowchart of a rebalancing processing according to the first embodiment;

FIG. 19 is a flowchart of LU reallocation plan creation processing according to the first embodiment;

FIG. 20 is an example of a distributed volume configuration change screen according to the first embodiment;

FIG. 21 is a diagram illustrating an outline of processing executed by a distributed storage system according to a second embodiment;

FIG. 22 is a configuration diagram of an object storage server according to the second embodiment;

FIG. 23 is a configuration diagram of a client server according to the second embodiment;

FIG. 24 is a configuration diagram of a storage device ID management table according to the second embodiment; and

FIG. 25 is a diagram illustrating an outline of data storage processing in the distributed storage system according to the second embodiment.

### DESCRIPTION OF THE PREFERRED EMBODIMENTS

Embodiments will be described with reference to the drawings. Note that the embodiments described below do not limit the invention according to the claims, and all of the elements described in the embodiments and combinations thereof are not necessarily essential to the solution of the invention.

In the following description, information will be sometimes described with an expression of an “AAA table”, but the information may be expressed with any data structure. That is, the “AAA table” can be referred to as “AAA information” to indicate that the information does not depend on the data structure. In the following description, the configuration of each table is an example, and one table may be divided into two or more tables, or all or some of two or more tables may be one table.

In the following description, a “network I/F” may include one or more communication interface devices. The one or more communication interface devices may be one or more communication interface devices of the same type (for example, one or more network interface cards (NIC)) or two or more communication interface devices of different types (for example, an NIC and a host bus adapter (HBA)).

In addition, in the following description, a storage apparatus may be a physical nonvolatile storage device (for example, an auxiliary storage device), for example, a hard disk drive (HDD), a solid state drive (SSD), or a storage class memory (SCM).

In the following description, a “memory” includes one or more memories. At least one memory may be a volatile memory or a nonvolatile memory. The memory is mainly used during processing executed by a processor.

In addition, in the following description, processing may be described with a “program” as an operation subject. The program is executed by a processor (for example, a central processing unit (CPU)) to execute predetermined processing by appropriately using a storage unit (for example, the memory) and/or an interface (for example, a port), and thus, the operation subject of the processing may be the program. The processing described with the program as the operation subject may be processing executed by the processor or a computer (for example, a server) including the processor. In addition, a controller (storage controller) may be the processor itself or may include a hardware circuit that executes some or all of pieces of processing executed by the controller. The program may be installed in each controller from a program source. The program source may be, for example, a program distribution server or a computer-readable (for example, non-transitory) storage medium. In the following description, two or more programs may be implemented as one program, or one program may be implemented as two or more programs.

In addition, in the following description, an ID is used as identification information of the element, but other types of identification information may be used instead of or in addition to the ID.

In addition, in the following description, in a case where elements of the same type are described without being distinguished from each other, common numbers in reference numerals may be used, and in a case where elements of the same type are described while being distinguished from each other, reference numerals of the elements may be used.

In addition, in the following description, a distributed storage system includes one or more physical computers (servers or nodes) and a storage array. The one or more physical computers may include at least one of a physical node or a physical storage array. At least one physical computer may execute a virtual computer (for example, a virtual machine (VM)) or may execute software-defined anything (SDx). As the SDx, for example, software defined storage (SDS) (an example of a virtual storage apparatus) or software-defined datacenter (SDDC) can be adopted.

### First Embodiment

First, an outline of a distributed storage system 0 according to a first embodiment will be described.

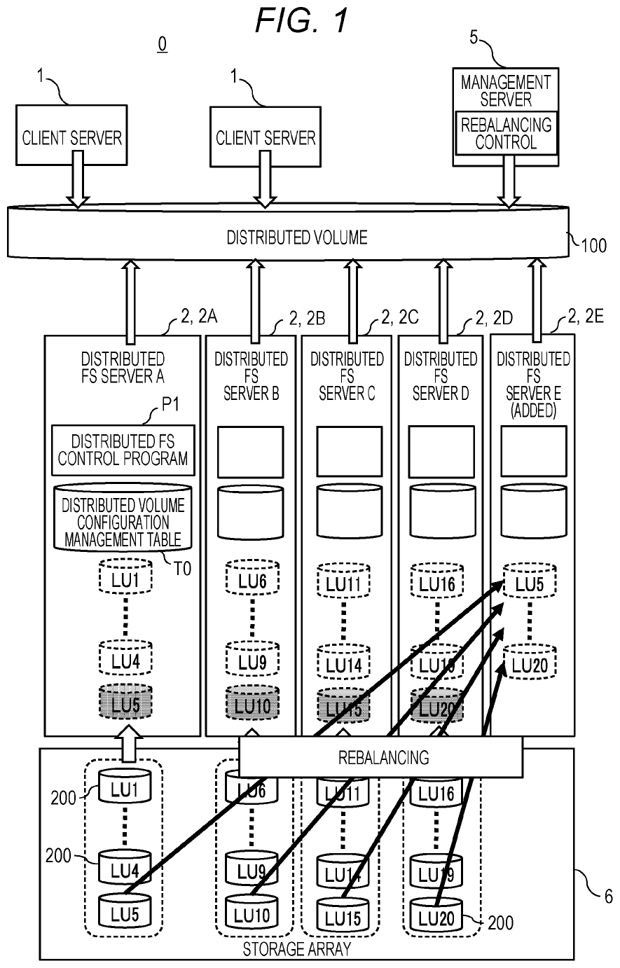

FIG. 1 is a diagram illustrating an outline of processing executed by the distributed storage system according to the first embodiment. FIG. 1 illustrates an outline of rebalancing processing at the time of increasing the number of servers in the distributed storage system 0.

The distributed storage system 0 includes a plurality of distributed file system (FS) servers 2 (2A, 2B, 2C, 2D, and the like) and one or more storage arrays 6. The distributed storage system 0 provides a distributed volume 100 (an example of a shared storage area) for storing user data to a client server 1. The storage array 6 provides an LU 200 (an example of a logical unit area) for the user data to the distributed FS server 2. The distributed volume 100 is configured by a bundle of a plurality of LUs 200 provided to the plurality of distributed FS servers 2. In the example of FIG. 1, the distributed volume 100 is configured by the LUs 200 provided to one or more distributed FS servers 2 including the distributed FS server 2A (distributed FS server A). In the present embodiment, the storage array 6 makes data redundant by incorporating a redundant array of inexpensive disks (RAID) configuration of the LU 200 in the storage array 6, and does not make data redundant between the distributed FS servers 2. Note that the distributed FS server 2 may have a function of performing a RAID control, and the LU 200 may be made redundant on the distributed FS server side.

The distributed storage system 0 stores the user data stored in the distributed volume 100, for example, in units of files. The distributed storage system 0 calculates a hash value from a file identifier, and distributes a file according to the hash value so as to make files be uniformly distributed among the distributed FS servers 2 (referred to as uniform distribution). Here, the file indicates a logical data management unit (an example of a data unit), and indicates a group of data that can be referred to by a file path. The file path indicates a location of the file, and is, for example, a character string representing a node having a tree structure configured with files and directories in which files are grouped. In the distributed storage system 0, a range of uniformly divided hash values is allocated to each LU 200. Note that the unit of storage in the distributed volume 100 is not limited to the file unit, and may be, for example, a chunk obtained by dividing a file. In this case, the hash value for each chuck may be calculated, and the chunks may be uniformly distributed among the distributed FS servers 2. For the chunk, for example, the hash value may be calculated based on the file identifier including the chunk and an identifier of the chunk.

The distributed FS server 2 stores the user data in the LU 200 with fine granularity created in the storage array 6. A management server 5 changes the distributed FS server 2 to which the LU 200 is to be allocated at the time of rebalancing. At this time, the management server 5 changes a server (a server in charge) in charge of the LU 200 in configuration information (LU allocation management table T7 (see FIG. 13)) of the LU 200 configuring the distributed volume 100, such that the range of the hash value of each LU 200 before and after the rebalancing is not changed. As a result, data migration via a network becomes unnecessary, and high-speed data rebalancing can be realized.

FIG. 1 illustrates an outline of rebalancing processing of rebalancing data of the distributed volume 100 configured by the LUs 200 (LU 1 to LU 20) managed by the distributed FS servers 2A to 2D in a case where a distributed FS server 2E (distributed FS server E) is added to the distributed storage system 0 including the distributed FS servers 2A to 2D.

In a case where the distributed FS server 2E is added, the distributed storage system 0 reallocates, to the distributed FS server 2E, some LUs 200 (LU 5, LU 10, LU 15, and LU 20) of the LUs 200 (LU 1 to LU 20) allocated to the distributed FS servers 2A to 2D. At this time, the configuration of the LU in the distributed volume 100 is not changed, and the range of the hash value of each LU 200 is not changed. In the distributed storage system 0, after the reallocation to the distributed FS server 2E, a distributed FS control program P1 notifies the client server 1 of data arrangement after the reallocation, and switches data access from the client server 1 to the distributed FS server 2 corresponding to the data arrangement after the rebalancing. As a result, the distributed storage system 0 can realize data rebalancing to the added distributed FS server 2E without involving network transfer for data migration between the distributed FS servers 2.

As described above, in the distributed storage system 0 according to the first embodiment, the distributed volume 100 is created with a large number (for example, the number is larger than the number of distributed FS servers 2) of LUs 200 in the storage array 6, and when the configuration of the distributed FS server 2 is changed, the LUs 200 are reallocated between the distributed FS servers 2, such that the data migration processing via the network is unnecessary. As a result, a time required for the data rebalancing processing can be significantly reduced.

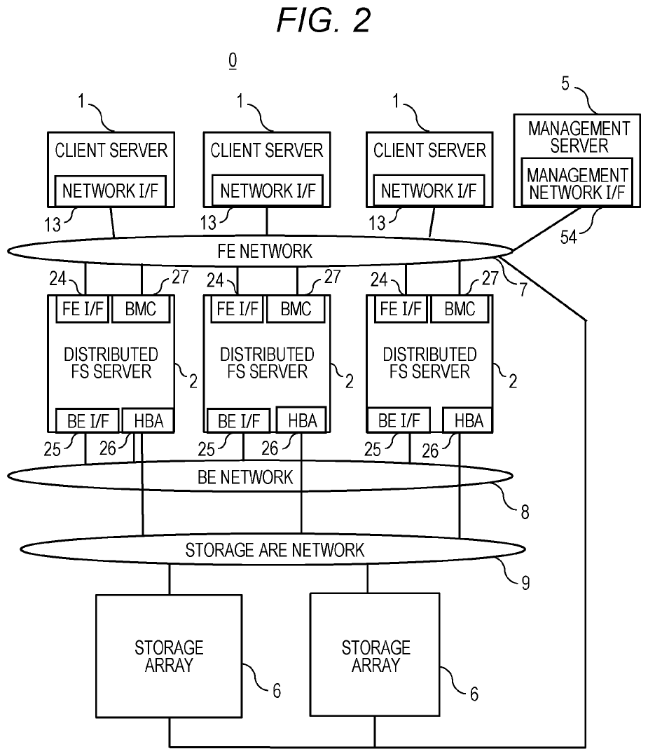

FIG. 2 is a configuration diagram of the distributed storage system according to the first embodiment.

The distributed storage system 0 includes one or more client servers 1, the management server 5 as an example of a management apparatus, the distributed FS servers 2 as an example of a plurality of distributed servers, one or more storage arrays 6, a frontend (FE) network 7, a backend (BE) network 8, and a storage area network (SAN) 9.

The client server 1 is a client of the distributed FS server 2. The client server 1 is connected to the FE network 7 via a network I/F 13, and issues an I/O (file I/O) for a file of the user data to the distributed FS server 2. The client server 1 performs file I/O according to a protocol such as a network file system (NFS), a server message block (SMB), or an Apple filing protocol (AFP). The client server 1 can also communicate with other apparatuses for various purposes.

The management server 5 is a server for a manager of the distributed storage system 0 to manage the distributed FS server 2 and the storage array 6. The management server 5 is connected to the FE network 7 via a management network I/F 54, and issues a management request to the distributed FS server 2 and the storage array 6. The management server 5 uses, as a communication form of the management request, command execution via Secure Shell (SSH), a representational state transfer application program interface (REST API), or the like. The management server 5 provides, to the manager, a management interface such as a command line interface (CLI), a graphical user interface (GUI), or a REST API.

The distributed FS server 2 configures a distributed file system that provides, to the client server 1, the distributed volume 100 which is a logical storage area. The distributed FS server 2 is connected to the FE network 7 via an FE network interface (abbreviated as FE I/F in FIG. 2) 24, and receives and processes the file I/O from the client server 1 and the management request from the management server 5. The distributed FS server 2 is connected to the SAN 9 via an HBA 26, and stores the user data and control information in the storage array 6. The distributed FS server 2 is connected to the BE network 8 via a BE network interface (abbreviated as BE I/F in FIG. 2) 25 and communicates with other distributed FS servers 2. The distributed FS server 2 exchanges metadata with another distributed FS server 2 and exchanges other information via the BE network 8. The distributed FS server 2 includes a baseboard management controller (BMC) 27, receives a power supply operation from the outside (for example, the management server 5 and the distributed FS server 2) at all times (including when a failure occurs), and processes the received power supply operation. The BMC 27 can use an intelligent platform management interface (IPMI) as a communication protocol.

The SAN 9 can use a small computer system interface (SCSI), an Internet Small Computer System Interface (iSCSI), nonvolatile Memory Express (NVMe), or the like as a communication protocol, and can use fibre channel (FC) or Ethernet (registered trademark) as a communication medium.

The storage array 6 includes a plurality of storage apparatuses. The storage array 6 is connected to the SAN 9, and provides the LU 200 to the distributed FS server 2 as a logical storage area for storing the user data and the control information managed by the distributed FS server 2.

In the distributed storage system 0 illustrated in FIG. 2, the FE network 7, the BE network 8, and the SAN 9 are separate networks, but the present invention is not limited to this configuration, and at least two of the FE network 7, the BE network 8, and the SAN 9 may be configured as the same network.

In addition, in the distributed storage system 0 illustrated in FIG. 2, an example in which the client server 1, the management server 5, and the distributed FS server 2 are physically separate servers is illustrated, but the present invention is not limited to this configuration. For example, the client server 1 and the distributed FS server 2 may be implemented by the same server, and the management server 5 and the distributed FS server 2 may be implemented by the same server.

Next, a configuration of the distributed FS server 2 will be described.

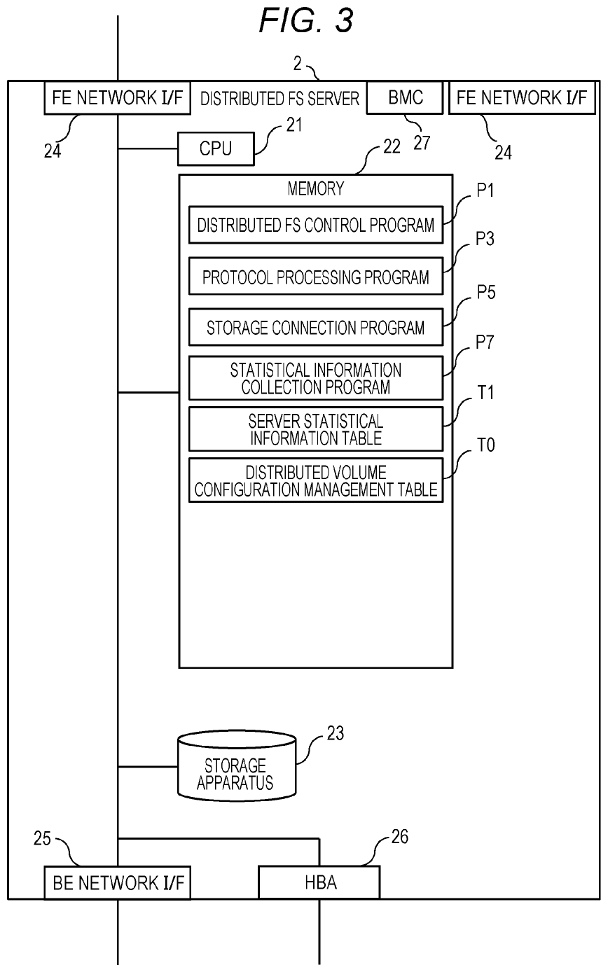

FIG. 3 is a configuration diagram of the distributed FS server according to the first embodiment.

The distributed FS server 2 includes a CPU 21, a memory 22, a storage apparatus 23, the FE network I/F 24, the BE network I/F 25, the HBA 26, and the BMC 27.

The CPU 21 provides a predetermined function by executing processing according to a program in the memory 22.

The memory 22 is, for example, a random access memory (RAM), and stores a program executed by the CPU 21 and necessary information. The memory 22 stores the distributed FS control program P1, a protocol processing program P3, a storage connection program P5, a statistical information collection program P7, a distributed volume configuration management table T0, and a server statistical information table T1.

The distributed FS control program P1 is executed by the CPU 21 to cooperate with the distributed FS control program P1 of another distributed FS server 2, thereby configuring the distributed file system (distributed FS). The distributed FS control program P1 is executed by the CPU 21 to provide the distributed volume 100 to the client server 1. The distributed FS control program P1 executes processing of storing a file stored in the distributed volume 100 by the client server 1 in the LU 200 in the storage array 6.

The protocol processing program P3 is executed by the CPU 21 to receive a request according to a network communication protocol such as NFS or SMB, convert the request into a file I/O for the distributed FS, and transfer the file I/O to the distributed FS control program P1.

The storage connection program P5 is executed by the CPU 21 to read data stored in the LU 200 of the storage array 6. The storage connection program P5 is executed by the CPU 21 to perform a control of communicating with the storage array 6 via a protocol for storage access, for the LU 200 allocated to the distributed FS control program P1 (distributed FS server 2).

The statistical information collection program P7 is executed by the CPU 21 to perform processing of periodically monitoring the load of the distributed FS server 2 and storing load information in the server statistical information table T1.

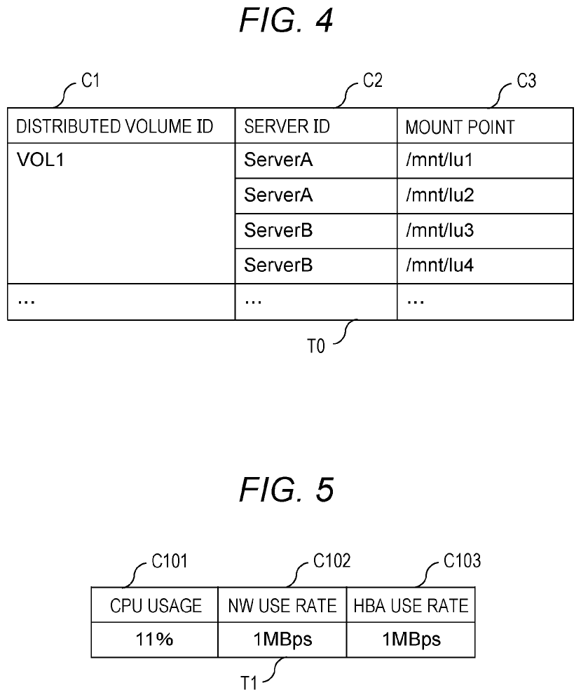

The distributed volume configuration management table T0 is a table for managing the configuration of the distributed volume 100. Details of the distributed volume configuration management table T0 will be described later with reference to FIG. 4.

The server statistical information table T1 stores information on the load of the distributed FS server 2. Details of the server statistical information table T1 will be described later with reference to FIG. 5.

The FE network I/F 24 is a communication interface device for connection to the FE network 7. The BE network I/F 25 is a communication interface device for connection to the BE network 8. The HBA 26 is a communication interface device for connection to the SAN 9.

The BMC 27 is a device that provides a power supply control interface of the distributed FS server 2. The BMC 27 is operated independently of the CPU 21 and the memory 22, and can receive a power supply control request from the outside and perform a power supply control even when a failure occurs in the CPU 21 or the memory 22.

The storage apparatus 23 is a nonvolatile storage medium storing various programs used in the distributed FS server 2. The storage apparatus 23 may be an HDD, an SSD, or an SCM.

Next, the configuration of the distributed volume configuration management table T0 will be described in detail.

FIG. 4 is a configuration diagram of the distributed volume configuration management table according to the first embodiment.

The distributed volume configuration management table T0 stores configuration information for configuring the distributed volume 100. The distributed volume configuration management table T0 is used by the distributed FS control program P1. The distributed FS control program P1 cooperates with the distributed FS control program P1 of another distributed FS server 2 to execute synchronization processing, such that the distributed volume configuration management tables T0 of all the distributed FS servers 2 are synchronized to always have the same contents.

The distributed volume configuration management table T0 stores an entry for each distributed volume 100. The entry of the distributed volume configuration management table T0 includes fields including a distributed Vol ID C1, a server ID C2, and a mount point C3. The server ID C2 and the mount point C3 correspond to each LU of the corresponding distributed volume 100.

The distributed volume ID C1 stores an identifier (distributed volume ID) of the distributed volume 100 corresponding to the entry. The server ID C2 stores an identifier (server ID) of the distributed FS server 2 configuring the LU 200 of the distributed volume 100 corresponding to the entry. The mount point C3 stores a mount point in the distributed FS server 2 on which the LU 200 configuring the distributed volume 100 corresponding to the entry is mounted. Here, the mount point refers to a virtual directory when accessing the mounted LU 200. According to the distributed volume management table T0, the distributed FS server 2 that manages each LU included in the distributed volume and the mount point can be specified.

Next, the configuration of the server statistical information table T1 will be described in detail.

FIG. 5 is a configuration diagram of the server statistical information table according to the first embodiment.

The server statistical information table T1 stores statistical information regarding the load of hardware of the distributed FS server 2. In the server statistical information table T1, information on the load of the hardware of the distributed FS server 2 monitored by the statistical information collection program P7 is stored.

The server statistical information table T1 includes fields including CPU usage C101, an NW use rate C102, and an HBA use rate C103.

The CPU usage C101 stores CPU usage of the distributed FS server 2 (own distributed FS server) that stores the server statistical information table T1. A network flow rate of the own distributed FS server is stored in the NW use rate C102. The HBA use rate C103 stores the HBA use rate of the own distributed FS server.

Note that, in the present embodiment, the CPU usage, the network flow rate, and the HBA use rate are stored as statistical information in the server statistical information table T1, but the present invention is not limited thereto. The statistical information may include the number of network packets, the number of times a disk is accessed, a memory use rate, and the like.

Next, a configuration of the storage array 6 will be described.

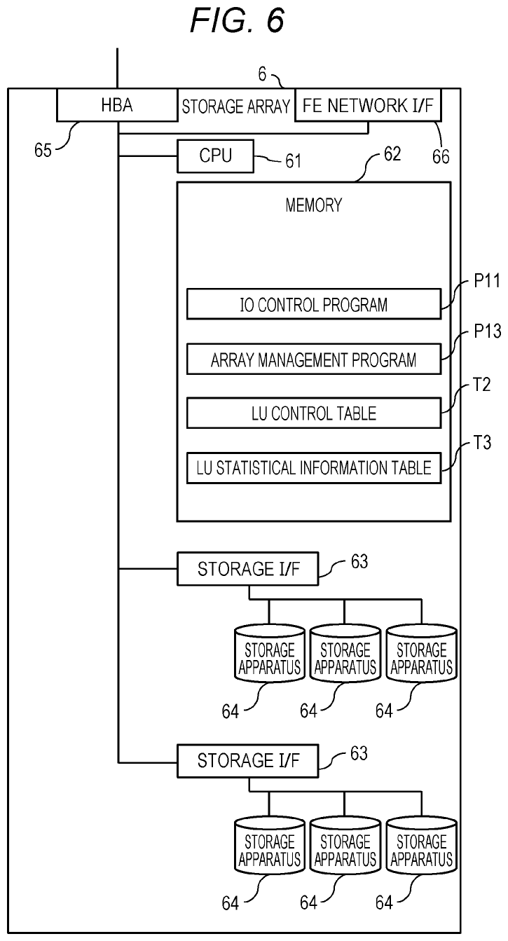

FIG. 6 is a configuration diagram of the storage array according to the first embodiment.

The storage array 6 includes a CPU 61, a memory 62, a storage I/F 63, a storage apparatus 64, an HBA 65, and an FE network I/F 66.

The CPU 61 provides a predetermined function by executing processing according to a program in the memory 62.

The memory 62 is, for example, a RAM, and stores a program executed by the CPU 61 and necessary information. The memory 62 stores an IO control program P11, an array management program P13, an LU control table T2, and an LU statistical information table T3.

The IO control program P11 is executed by the CPU 61 to process an I/O request with respect to the LU 200 received via the HBA 65 and read/write data from/to the storage apparatus 64. The array management program P13 is executed by the CPU 61 to create, extend, reduce, and delete the LU 200 in the storage array 6 according to an LU management request received from the management server 5.

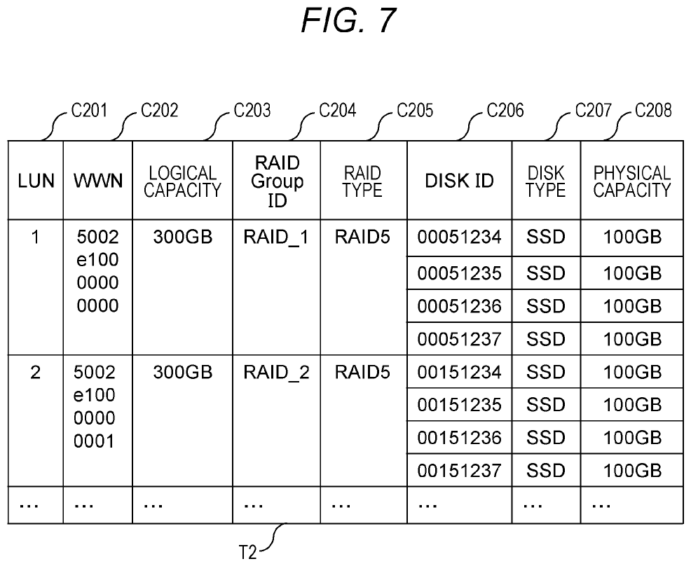

The LU control table T2 is a table for managing the control information of the LU 200. Details of the LU control table T2 will be described later with reference to FIG. 7.

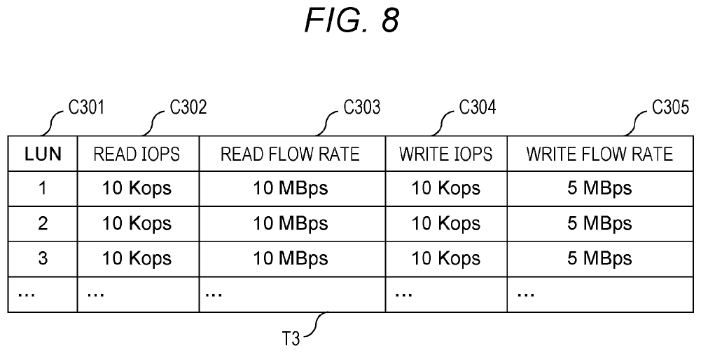

The LU statistical information table T3 stores information on the load of the LU 200. Details of the LU statistical information table T3 will be described later with reference to FIG. 8.

The storage I/F 63 is an interface that mediates reading and writing of data from and to the storage apparatus 64 by the CPU 61, and an interface such as a fibre channel (FC), a serial attached technology attachment (SATA), a serial attached SCSI (SAS), or integrated device electronics (IDE) is used for communication between the CPU 61 and the storage I/F 63.

The storage apparatus 64 is a storage medium that records various programs used in the storage array 6 and the user data and control information managed by the distributed FS server 2. As the storage medium of the storage apparatus 64, many types of storage media such as an HDD, an SSD, an SCM, a flash memory, an optical disk, a magnetic tape, and the like can be used.

The FE network I/F 66 is a communication interface device for connection to the FE network 7. The HBA 65 is a communication interface device for connection to the SAN 9.

Next, the configuration of the LU control table T2 will be described in detail.

FIG. 7 is a configuration diagram of the LU control table according to the first embodiment.

The LU control table T2 stores control information of the LU 200 provided by the storage array 6. The LU control table T2 stores an entry for each LU 200. The entry of the LU control table T2 includes fields including an LUN C201, a world wide name (WWN) C202, a logical capacity C203, a RAID group ID C204, a RAID type C205, a disk ID C206, a disk type C207, and a physical capacity C208.

The LUN C201 stores an identifier (LUN) of the LU 200 corresponding to the entry in the storage array 6. The WWN C202 stores an identifier (WWN) for uniquely identifying the LUN of the LU corresponding to the entry in the SAN 9. The WWN is used when the distributed FS server 2 accesses the LU 200. The logical capacity C203 stores a logical capacity of the LU 200 corresponding to the entry.

The RAID group ID C204 stores an identifier of a RAID group configuring the LU 200 corresponding to the entry. Here, the RAID group indicates a logical storage area configured by one or more storage media (for example, a disk) and to or from which data can be written or read. Note that a plurality of LUs 200 may be configured by one RAID group. The RAID type C205 stores the type (RAID type: RAID level) of the RAID group of the RAID group ID corresponding to the entry is stored. Examples of the RAID type include RAID 1 (nD+nD), RAID 5 (nD+1P), and RAID 6 (nD+2P). In addition, n and m respectively represent the number of redundant data with respect to the number of data in the RAID group.

The disk ID C206 stores an identifier (disk ID) of a disk included in the RAID group corresponding to the entry. As the disk ID, a serial number of the disk or the like may be used. The disk type C207 stores the type of disk (disk type) corresponding to the entry. The disk type includes an NVMe SSD, an SSD, an HDD, and the like. The physical capacity C208 stores a physical storage capacity of the disk corresponding to the entry.

Next, the configuration of the LU statistical information table T3 will be described in detail.

FIG. 8 is a configuration diagram of the LU statistical information table according to the first embodiment.

The LU statistical information table T3 stores information on the load of the LU 200 of the storage array 6. In the LU statistical information table T3, the load of the storage array 6 monitored by the IO control program P11 is periodically stored. The LU statistical information table T3 stores an entry for each LU. The entry of the LU statistical information table T3 includes fields including an LUN C301, a read IOPS C302, a read flow rate C303, a write IOPS C304, and a write flow rate C305.

The LUN C301 stores an LUN of the LU corresponding to the entry. The read IOPS C302 stores a read input/output per second (IOPS) for the LU corresponding to the entry. The read flow rate C303 stores a read data amount (read flow rate) per unit time for the LU corresponding to the entry. The write IOPS C304 stores a write IOPS for the LU corresponding to the entry. The write flow rate C305 stores a write data amount (write flow rate) per unit time for the LU corresponding to the entry.

Next, a configuration of the management server 5 will be described.

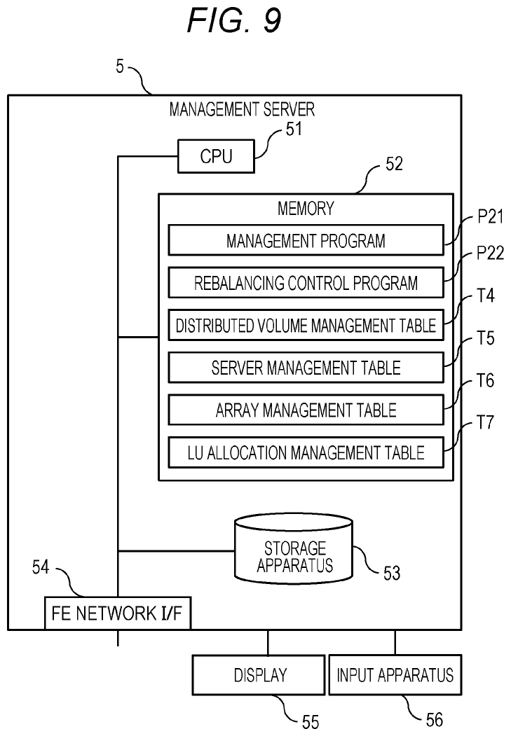

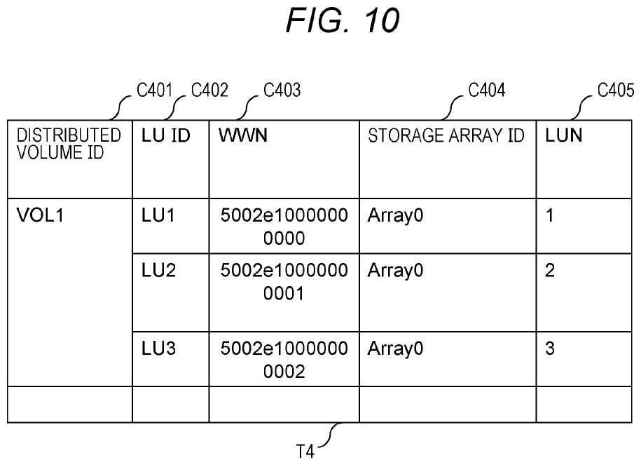

FIG. 9 is a configuration diagram of the management server according to the first embodiment.

The management server 5 includes a CPU 51 as an example of a processor, a memory 52, a storage apparatus 53, and an FE network I/F 54. A display 55 and an input apparatus 56 are connected to the management server 5.

The CPU 51 provides a predetermined function by executing processing according to a program in the memory 52.

The memory 52 is, for example, a RAM, and stores a program executed by the CPU 51 and necessary information. The memory 52 stores a management program P21, a rebalancing control program P22, a distributed volume management table T4, a server management table T5, an array management table T6, and the LU allocation management table T7. Note that a management program in the claims corresponds to the management program P21 and the rebalancing control program P22.

The management program P21 is executed by the CPU 51 to issue a configuration change request to the distributed FS server 2 and the storage array 6 according to the management request received from the manager via the input apparatus 56. Here, the management request from the manager includes a request for creation/deletion of the distributed volume 100, an increase or decrease of the number of the distributed FS servers 2, and the like. In addition, the configuration change request includes a request for creation, deletion, extension, and reduction of the LU, and addition, deletion, and change of an LU path.

The rebalancing control program P22 is executed by the CPU 51 to execute data rebalancing processing in cooperation with the distributed FS server 2 and the storage array 6.

The distributed volume management table T4 is a table for managing the distributed volume 100. Details of the distributed volume management table T4 will be described later with reference to FIG. 10.

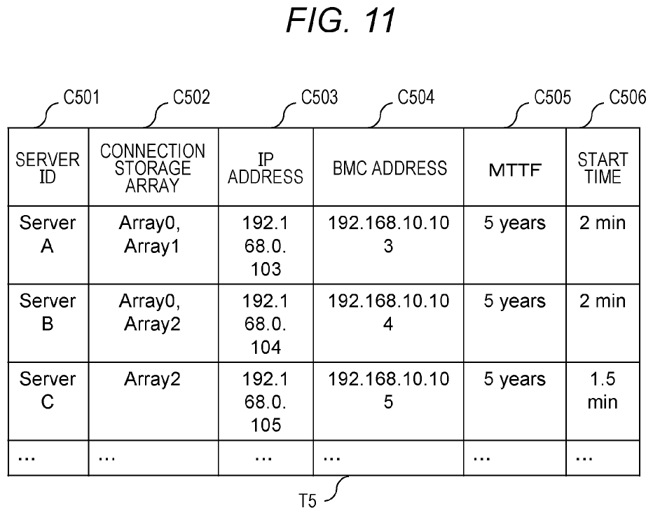

The server management table T5 is a table for managing the distributed FS server 2. Details of the server management table T5 will be described later with reference to FIG. 11.

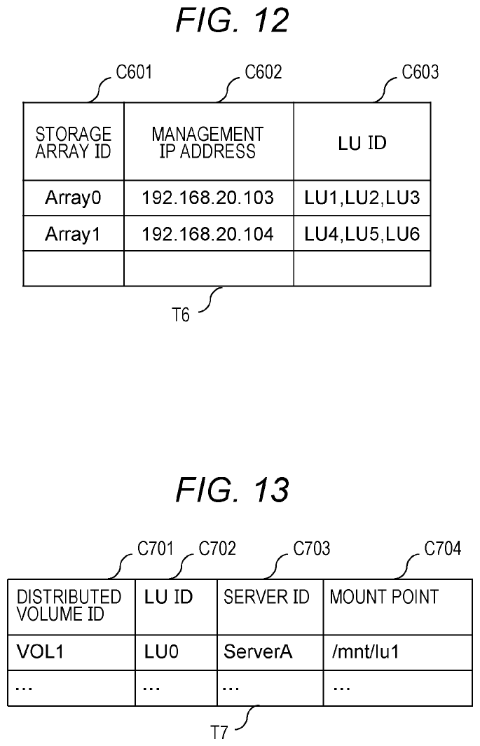

The array management table T6 is a table for managing the storage array 6. Details of the array management table T6 will be described later with reference to FIG. 12.

The LU allocation management table T7 is a table for managing allocation of the LU 200. Details of the LU allocation management table T7 will be described later with reference to FIG. 13.

The FE network I/F 54 is a communication interface device for connection to the FE network 7.

The storage apparatus 53 is a nonvolatile storage medium storing various programs used by the management server 5. The storage apparatus 53 may be an HDD, an SSD, or an SCM.

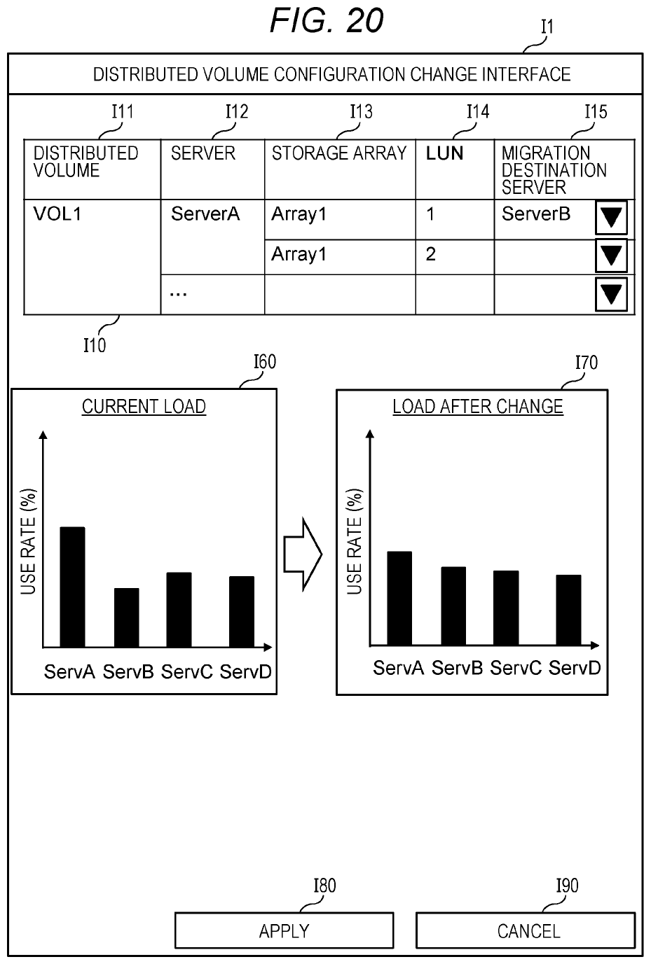

The input apparatus 56 is a keyboard, a mouse, a touch panel, or the like, and receives an operation made by a user (or the manager). The display 55 is an apparatus that displays various types of information, and displays a screen (for example, a distributed volume configuration change screen in FIG. 20) of a management interface for managing the distributed storage system 0.

Next, the configuration of the distributed volume management table T4 will be described in detail.

FIG. 10 is a configuration diagram of the distributed volume management table according to the first embodiment.

The distributed volume management table T4 stores management information for the management program P21 to manage the distributed volume 100. The distributed volume management table T4 stores an entry for each distributed volume 100. The entry of the distributed volume management table T4 includes fields including a distributed Vol ID C401, an LU ID C402, a WWN C403, a storage array ID C404, and an LUN C405.

The distributed volume ID C401 stores an identifier (distributed volume ID) of the distributed volume 100 corresponding to the entry. The LU ID C402 stores an identifier (LU ID) for uniquely identifying one or more LUs 200 configuring the distributed volume 100 corresponding to the entry in the distributed storage system 0. The WWN C403 stores a WWN of the LU 200 of the LU ID corresponding to the entry. The storage array ID C404 stores an identifier (storage array ID) of the storage array 6 that stores the LU 200 corresponding to the entry. The LUN 405 stores an LUN of the LU 200 corresponding to the entry.

Next, the configuration of the server management table T5 will be described in detail.

FIG. 11 is a configuration diagram of the server management table according to the first embodiment.

The server management table T5 stores management information for the management program P21 to manage the distributed FS server 2. The server management table T5 stores an entry for each distributed FS server 2. The entry of the server management table T5 includes fields including a server ID C501, a connection storage array C502, an IP address C503, a BMC address C504, an MTTF C505, and a start time C506.

The server ID C501 stores an identifier (server ID) of the distributed FS server 2 that can be used to uniquely identify the distributed FS server 2 corresponding to the entry in the distributed storage system 0. The connection storage array C502 stores an identifier (storage array ID) of the storage array 6 accessible from the distributed FS server 2 corresponding to the entry. The IP address C503 stores an IP address of the distributed FS server 2 corresponding to the entry.

The BMC address C504 stores an IP address of the BMC 27 of the distributed FS server 2 corresponding to the entry. The MTTF C505 stores a mean time to failure (MTTF) of the distributed FS server 2 corresponding to the entry. As the MTTF, a catalog value for the distributed FS server corresponding to the entry or the server type may be used. The start time C506 stores a start time in a normal state of the distributed FS server 2 corresponding to the entry. The start time is used by the management program P21 to estimate a fail-over time.

Note that, in the server management table T5 illustrated in FIG. 11, the IP address is stored as information for access to the distributed FS server 2 and the BMC 27, but a host name may be stored instead.

Next, the configuration of the array management table T6 will be described in detail.

FIG. 12 is a configuration diagram of the array management table according to the first embodiment.

The array management table T6 stores configuration information of the storage array 6 used by the management program P21 to communicate with the storage array 6 and determine the allocation of the LU 200. The array management table T6 stores an entry for each storage array 6. The entry of the array management table T6 includes fields including a storage array ID C601, a management IP address C602, and an LU ID C603.

The storage array ID C601 stores an identifier (storage array ID) that can be used to uniquely identify the storage array 6 corresponding to the entry in the distributed storage system 0. The management IP address C602 stores an IP address for management of the storage array 6 corresponding to the entry. Note that a host name may be used instead of the IP address. The LU ID C603 stores an LU ID of the LU 200 provided by the storage array 6 corresponding to the entry.

Next, the configuration of the LU allocation management table T7 will be described in detail.

FIG. 13 is a configuration diagram of the LU allocation management table according to the first embodiment.

The LU allocation management table T7 stores management information for managing the LU 200 allocated to the distributed FS server 2 by the management program P21. The LU allocation management table T7 stores an entry for each LU 200 of the distributed volume 100. The entry of the LU allocation management table T7 includes fields including a distributed volume ID C701, an LU ID C702, a server ID C703, and a mount point C704.

The distributed volume ID C701 stores an identifier (distributed volume ID) of the distributed volume 100 corresponding to the entry. The LU ID C702 stores an identifier (LU ID) of the LU 200 of the distributed volume 100 corresponding to the entry. The server ID C703 stores a server ID of the distributed FS server 2 to which the LU 200 corresponding to the entry is allocated. The mount point C704 stores a mount point of the LU 200 corresponding to the entry in the distributed FS server 2.

Next, a configuration of the client server 1 will be described.

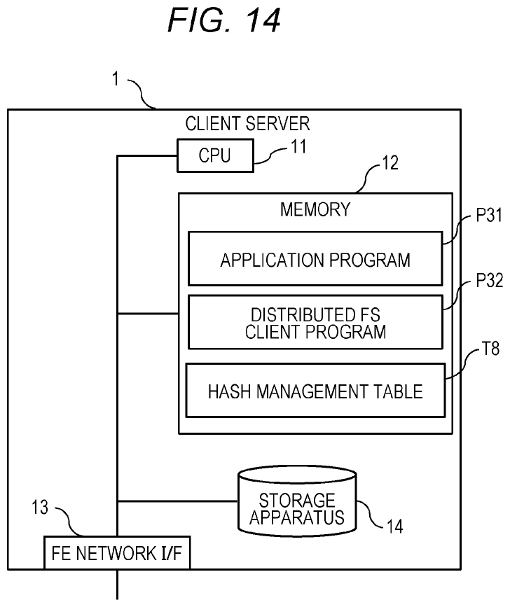

FIG. 14 is a configuration diagram of the client server according to the first embodiment.

The client server 1 includes a CPU 11, a memory 12, a storage apparatus 14, and an FE network I/F 13.

The CPU 11 provides a predetermined function by executing processing according to a program in the memory 12.

The memory 12 is, for example, a RAM, and stores a program executed by the CPU 11 and necessary information. The memory 12 stores an application program P31, a distributed FS client program P32, and a hash management table T8.

The application program P31 is executed by the CPU 11 to execute data processing by using the distributed volume 100. The application program P31 may be, for example, a program such as a relational database management system (RDBMS) or a VM hypervisor.

The distributed FS client program P32 is executed by the CPU 11 to issue a file I/O to the distributed FS server 2 and read and write data from and to the distributed volume 100. The distributed FS client program P32 performs a control on the client side in the network communication protocol. The distributed FS client program P32 creates a physical directory corresponding to a relevant directory for all the LUs 200 at the time of creating a new directory. At this time, the distributed FS client program P32 records the hash value allocated to the LU 200 in metadata of the directory in the LU 200. When accessing the directory, the distributed FS client program P32 reads the metadata of the physical directories of all the LUs 200 and records the read metadata in the hash management table T8. The distributed FS client program P32 calculates the hash value of the file identifier at the time of file access, refers to the hash management table T8, and specifies the LU 200 that is a storage destination based on the hash value.

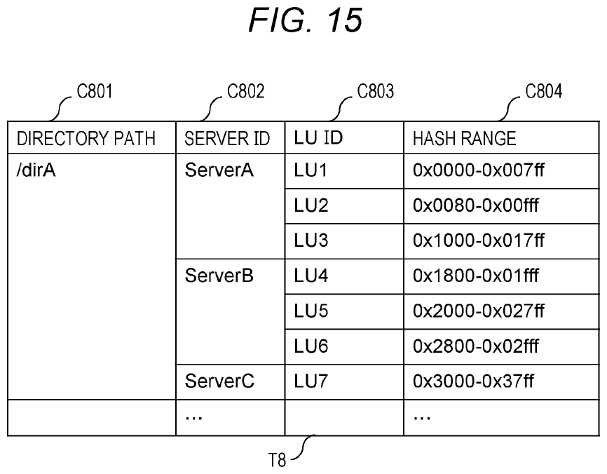

The hash management table T8 is a table for managing hash information of a file stored in the LU 200. Details of the hash management table T8 will be described later with reference to FIG. 15.

The FE network I/F 13 is a communication interface device for connection to the FE network 7.

The storage apparatus 14 is a nonvolatile storage medium storing various programs used by the client server 1. The storage apparatus 14 may be an HDD, an SSD, or an SCM.

Next, the configuration of the hash management table T8 will be described in detail.

FIG. 15 is a configuration diagram of the hash management table according to the first embodiment.

The hash management table T8 stores hash information for the distributed FS client program P32 on the client server 1 to access a file managed by the distributed FS server 2. The hash management table T8 includes fields including a directory path C801, a server ID C802, an LU ID C803, and a hash range C804.

The directory path C801 stores a path of a directory (directory path) having a hash value. In all the directories in the distributed volume 100, a range of the hash value is associated with each LU 200. The server ID C802 stores an identifier (server ID) of the distributed FS server 2 that stores a file under the directory corresponding to the entry. The server ID C802 stores server IDs of all the servers in the directory path corresponding to the entry.

The LU ID C803 stores an identifier (LU ID) of the LU 200 managed by the distributed FS server 2 of the directory path corresponding to the entry. The LU ID C803 stores LU IDs of all the LUs 200 managed by the distributed FS server 2 corresponding to the entry. The hash range C804 stores the range of the hash value for the file stored in the LU 200 of the LU ID corresponding to the entry.

Next, an outline of data storage processing in the distributed storage system 0 according to the first embodiment will be described.

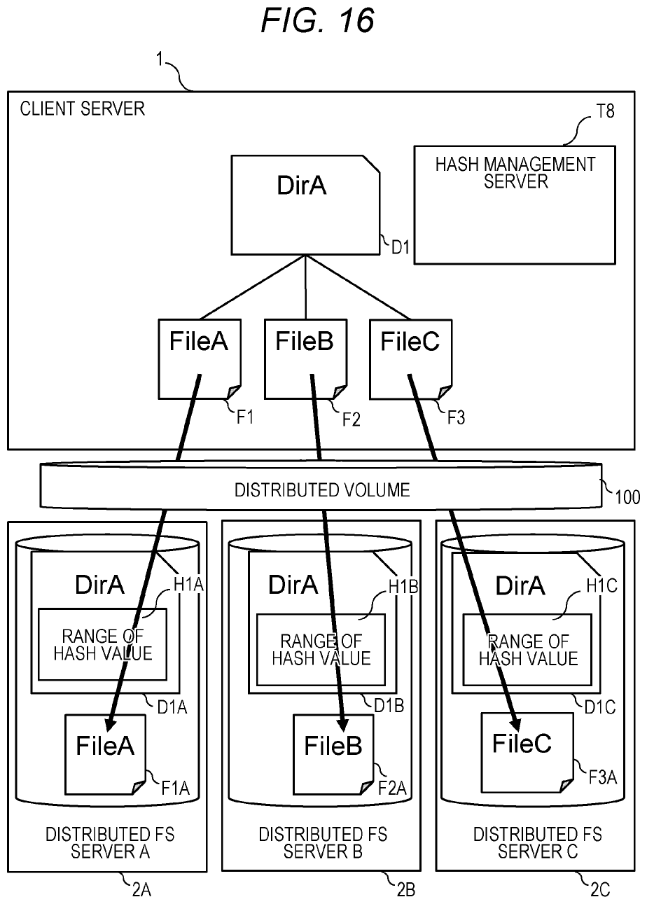

FIG. 16 is a diagram illustrating the outline of the data storage processing in the distributed storage system according to the first embodiment.

FIG. 16 illustrates the outline of the processing in a case where the client server 1 stores directories D1A to D1C (DirA) and files F1 to F3 (FileA to FileC) in the distributed volume 100 configured by the distributed FS servers 2A to 2C.

The directory in the distributed volume 100 is created as the same directory path in the LUs 200 in all the distributed FS servers 2 configuring the distributed volume 100. Here, the directory path indicates a character string for accessing the directory. The plurality of files in the distributed volume 100 are distributed and stored among the distributed FS servers 2 based on the hash value of the file identifier. Here, as the file identifier, the file path or a random number allocated at the time of file generation may be used. As a result, DirA is present in all the LUs 200 of the distributed FS server 2, and FileA to FileC are present in different LUs 200.

In the directory D1 (D1A to D1C) in the LU 200 of each distributed FS server 2, a range H1 (H1A to H1C) of the hash value allocated to the LU 200 is managed as the metadata.

The distributed FS client program P32 on the client server 1 determines the range H1 of the hash value of each LU 200 at the time of creating a new directory, and stores the range H1 in the metadata of the directory D1 of each LU 200. In addition, the distributed FS client program P32 acquires the ranges H1 (H1A to H1C) of the hash values corresponding to all the LUs 200 from all the distributed FS server 2 at the time of accessing the directory, and records the ranges H1 in the hash management table T8.

At the time of file access, the distributed FS client program P32 calculates the hash value based on the file identifier, refers to the hash management table T8, and specifies a server that manages the LU 200 corresponding to the calculated hash value.

Next, a processing operation of the distributed storage system 0 according to the first embodiment will be described.

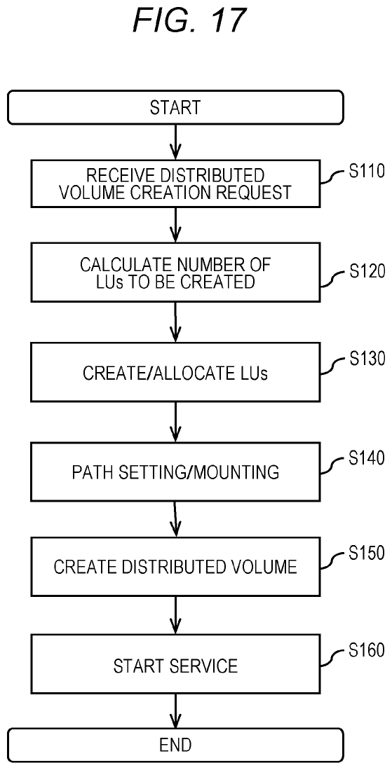

FIG. 17 is a flowchart of volume creation processing according to the first embodiment.

The volume creation processing is processing executed by the management server 5, in which once a distributed volume creation request is received from the manager via, for example, the input apparatus 56 or a terminal used by the manager, the management program P21 (strictly speaking, the CPU 51 of the management server 5 that executes the management program P21) creates the shared LU 200 with fine granularity in the storage array 6 based on the distributed volume creation request.

Step S110: The management program P21 receives the distributed volume creation request including a new volume name, a volume size, an operation rate requirement, and the like from the manager.

Step S120: The management program P21 determines the number of LUs (the number of LUs to be created) configuring the new volume based on the maximum number of servers that can be added to the distributed volume.

Specifically, for example, the management program P21 refers to the server management table T5, calculates the average value of the MTTFs of the distributed FS servers 2 included in the distributed storage system 0, calculates an operation rate estimate for each number of distributed FS servers in a case where the number of distributed FS servers is changed based on Equation (1), and calculates the maximum number of servers that satisfies the operation rate requirement of the distributed volume creation request based on the result. The management program P21 determines the same number as the maximum number of servers as the number of LUs 200 with fine granularity configuring the distributed volume. Note that the number of LUs 200 may be larger than the current number of distributed FS servers of the distributed storage system 0 and may be equal to or smaller than the maximum number of servers.

Operation Rate Estimate=Π((MTTFₛₑᵣᵥₑᵣ−F.o.Timeₛₑᵣᵥₑᵣ)/(MTTFₛₑᵣᵥₑᵣ)) (1)

Here, Π is a function indicating the total power, and in the present embodiment, Π represents an infinite product of the number of target servers, MTTFₛₑᵣᵥₑᵣ represents the MTTF of the distributed FS server 2, and F.O.Timeₛₑᵣᵥₑᵣ represents a time (F.O.Time) required to fail over the distributed FS server 2. In the present embodiment, as the MTTF, the average value of the MTTF C505 of the distributed FS server in the server management table T5 is used, and as the F.O.Timeₛₑᵣᵥₑᵣ, for example, a value obtained by adding a predetermined time (for example, 1 minute) to the value of the start time C506 of the server management table T5 is used. Note that a method of estimating the MTTF and the F.O.Time is not limited thereto, and other methods may be used.

By making the number of LUs 200 the same as the maximum number of servers in this manner, it is possible to rebalance the LUs 200 among the distributed FS servers 2 up to the maximum number of servers (the limit number of servers) included in the distributed volume 100. In addition, since the number of LUs is determined based on the operation rate of the distributed FS server, it is possible to dynamically calculate the optimum number of LUs according to the reliability of the number of distributed FS servers used in the distributed storage system 0. Note that, although the maximum number of servers is determined based on the operation rate, the present invention is not limited thereto, and for example, a fixed maximum number of servers set in advance may be used.

Step S130: The management program P21 calculates the data capacity per LU by dividing the volume size of the distributed volume creation request by the number of LUs to be created. Next, the management program P21 instructs the storage array 6 to create LUs with the calculated data capacity by the number of LUs to be created, thereby creating the LUs 200. Next, the management program P21 uniformly allocates the plurality of created LUs 200 to the operating distributed FS servers 2, and updates the distributed volume management table T4 and the LU allocation management table T7 so as to correspond to the allocated information.

Step S140: The management program P21 instructs the storage connection program P5 on the distributed FS server 2 to connect the LU 200 allocated in Step S130. The storage connection program P5 that has received the instruction mounts the LU 200 corresponding to the LUN of the storage array 6 instructed from the management program P21 at a designated mount point.

Step S150: The management program P21 instructs the distributed FS control program P1 of the distributed FS server 2 to create the distributed volume 100. As a result, the distributed FS control program P1 creates the distributed volume 100 by updating the configuration corresponding to the distributed volume 100 in the distributed volume configuration management table T0.

Step S160: The management program P21 instructs the distributed FS control program P1 of the distributed FS server 2 to start a service of the created distributed volume 100. As a result, the distributed FS control program P1 starts the service of the created distributed volume 100.

With the volume creation processing described above, the distributed volume 100 including an appropriate number of LUs 200 in the storage array 6 can be created, and the rebalancing processing can be appropriately executed by processing to be described later.

Next, the rebalancing processing executed by the management server 5 will be described.

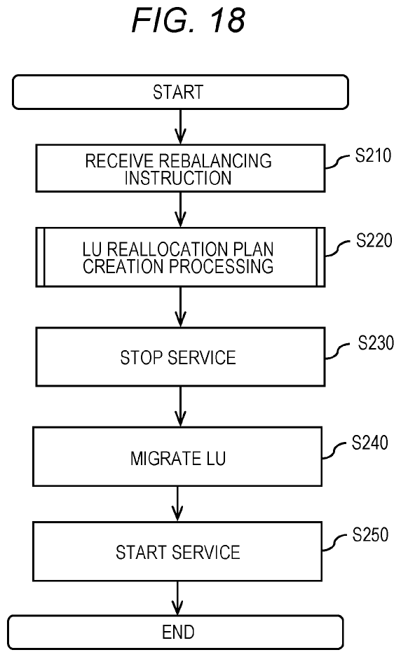

FIG. 18 is a flowchart of the rebalancing processing according to the first embodiment.

In the rebalancing processing, the rebalancing control program P22 (strictly speaking, the CPU 51 of the management server 5 that executes the rebalancing control program P22) realizes the rebalancing of the load between the distributed FS servers 2 by reallocating the LUs 200 between the distributed FS servers 2 when increasing or decreasing the number of distributed FS servers. At the time of the LU reallocation, by taking over the configuration of the LU 200 of the distributed volume 100 and taking over the range of the hash value already allocated to the LU 200, it becomes unnecessary to migrate the data of the LU 200 between the distributed FS servers 2 via the network.

In the rebalancing processing, the rebalancing control program P22 reallocates the LUs 200 so that the LUs 200 configuring the distributed volume 100 are uniformly distributed among the distributed FS servers 2, and the loads are equal among the distributed FS servers 2. At this time, in addition to the load distribution, the rebalancing control program P22 determines the LU 200 to be reallocated so that the number of LUs to be migrated is decreased to minimize a reallocation time for the LUs 200 among the distributed FS servers 2.

Step S210: The rebalancing control program P22 receives a distributed volume rebalancing request including a distributed volume name (target volume name) that is a rebalancing target from the manager or the management program P21.

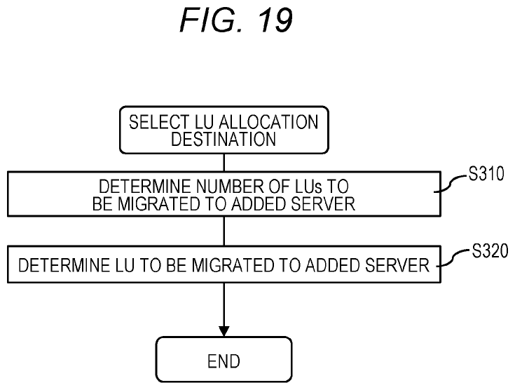

Step S220: The rebalancing control program P22 executes LU reallocation plan creation processing of creating a plan for reallocating the LU 200 (LU reallocation plan) necessary for realizing the data rebalancing. The LU reallocation plan is determined so that the numbers of LUs 200 are equal between the distributed FS servers 2 that manage the LUs 200 configuring the distributed volume 100, and the loads are equal between the distributed FS servers 2. Note that, in a case where the LU 200 to be rebalanced is designated in the request, the rebalancing control program P22 uses the content of the request as it is for the reallocation plan. Details of the LU reallocation plan creation processing will be described later with reference to FIG. 19.

Step S230: The rebalancing control program P22 instructs the distributed FS control program P1 of the distributed FS server to temporarily stop the service (access to data of the distributed volume 100) of the distributed volume 100 that is the rebalancing target. As a result, the distributed FS control program P1 of the distributed FS server 2 temporarily stops the service of the distributed volume 100 that is the rebalancing target.

Step S240: The rebalancing control program P22 reallocates the LUs 200 to the distributed FS servers 2 based on the LU reallocation plan created in Step S220. Specifically, the rebalancing control program P22 instructs the storage connection program P5 of the distributed FS server 2 that is a migration source of the LU 200 to release the connection to the corresponding LU 200 in the LU reallocation plan. As a result, the storage connection program P5 releases the connection to the corresponding LU 200. Thereafter, the rebalancing control program P22 instructs the storage connection program P5 of the distributed FS server 2 that is a migration destination of the LU to be connected to the corresponding LU 200, and to mount the LU 200 on the designated path. The storage connection program P5 that has received the instruction connects the corresponding LU 200 and mounts the LU on the designated path. Next, the rebalancing control program P22 instructs the distributed FS control program P1 of the distributed FS server 2 to update the value of the server ID C2 corresponding to the path of the LU of the distributed volume configuration management table T0 to a server ID of the migration destination. The distributed FS control program P1 updates the value of the server ID C2 corresponding to the path of the LU of the distributed volume configuration management table T0 to the server ID of the migration destination. As a result, a correspondence relationship between the LU 200 and the distributed FS server 2 that performs management is reflected. Next, the rebalancing control program P22 updates the server ID C703 of the LU allocation management table T7 to the server ID of the migration destination.

Step S250: The rebalancing control program P22 instructs the distributed FS control program P1 of the distributed FS server 2 to resume the service of the distributed volume 100. The distributed FS control program P1 resumes the service of the distributed volume 100. Thereafter, at the time of reconnection to the distributed volume 100, the client server 1 receives the correspondence relationship between the LU 200 and the distributed FS server 2 transmitted from the distributed FS control program P1 of the distributed FS server 2, and updates the hash management table T8 based on the correspondence relationship.

Next, the LU reallocation plan creation processing in Step S220 will be described.

FIG. 19 is a flowchart of the LU reallocation plan creation processing according to the first embodiment. The LU reallocation plan creation processing of FIG. 19 is LU reallocation plan creation processing at the time of increasing the number of distributed FS servers 2.

The rebalancing control program P22 creates the LU reallocation plan in consideration of equalization of the loads in the distributed volume 100 and between the distributed FS servers at the time of increasing the number of distributed FS servers. At this time, in order to shorten the rebalancing time, as few LUs 200 as possible are migrated.

Step S310: The rebalancing control program P22 determines the number of LUs to be migrated to the added distributed FS server for each distributed volume by using the following Equation (2).

The number of LUs to be migrated to the added server=floor (the total number of LUs of the target distributed volume/the number of servers after the increase) (2)

Here, floor means rounding down to an integer.

Step S320: The rebalancing control program P22 acquires the LU statistical information table T3 from the storage array 6, and calculates the load of each distributed FS server 2 based on the LU statistical information table T3. Next, the rebalancing control program P22 sorts the plurality of distributed FS servers 2 in descending order of load. Next, for each volume, the rebalancing control program P22 selects, as the LUs to be reallocated, the LUs 200 of the volume corresponding to the number of LUs to be migrated obtained in Step S310 for the distributed FS server 2 in descending order of load by round robin, and creates the LU reallocation plan including information on the LUs to be reallocated, the distributed FS server 2 that is a migration source of the LUs to be reallocated, and the distributed FS server 2 that is a migration destination (allocation destination). By performing the LU reallocation according to the LU reallocation plan, the loads of the respective distributed FS servers 2 can be equalized.

Note that FIG. 19 illustrates the LU reallocation plan creation processing at the time of increasing the number of distributed FS servers 2. At the time of decreasing the number of distributed FS servers 2, the processing of Step S310 is omitted, and the rebalancing control program P22 determines the distributed FS server 2 that is a migration destination of the LU 200 of the distributed FS server 2 to be deleted. In this case, the rebalancing control program P22 acquires the LU statistical information table T3 from the storage array 6, calculates the load of each distributed FS server 2 based on the LU statistical information table T3, and sorts the distributed FS servers 2 in ascending order of load. Next, the rebalancing control program P22 allocates, as a migration destination of the LUs 200 to be reallocated of the distributed FS server 2 to be deleted, the distributed FS server 2 in ascending order of load, and creates the LU reallocation plan including information on the LUs to be reallocated, the distributed FS server 2 that is the migration source of the LUs to be reallocated, and the distributed FS server 2 that is the migration destination. By performing the LU reallocation according to the LU reallocation plan, the loads of the respective distributed FS servers 2 can be equalized.

In addition, after the LU reallocation plan creation processing at the time of increasing or decreasing the number of distributed FS servers 2 described above is executed, the rebalancing control program P22 may calculate the load of the distributed FS server 2 assumed in a case where the LU reallocation plan creation processing is executed based on the LU statistical information table T3, and update the LU reallocation plan for reallocating the LUs so as to equalize the loads of the respective distributed FS servers 2.

Next, the screen of the management interface for the distributed volume creation management provided by the management program P21 will be described.

FIG. 20 is an example of the distributed volume configuration change screen according to the first embodiment. A distributed volume configuration change screen I1 is displayed on, for example, the display 55 connected to the management server 5.

The manager can perform the data rebalancing of the distributed volume 100 through the distributed volume configuration change screen I1.

The distributed volume configuration change screen I1 includes a configuration change display area I10, a current load display area I60, a post-change load display area I70, an apply button I80, and a cancel button I90.

The configuration change display area I10 is an area for displaying and selecting the migration destination of the LU of the distributed volume 100, and includes a distributed volume display area I11, a server display area I12, a storage array display area I13, an LUN display area I14, and a migration destination server selection display area I15. In the distributed volume display area I11, the distributed volume ID is displayed. In the server display area I12, the server ID of the distributed FS server 2 that manages the LU 200 configuring the distributed volume is displayed. In the storage array display area I13, the storage array ID of the storage array 6 that stores the LU 200 is displayed. In the LUN display area I14, the LU ID of the LU 200 is displayed. In the migration destination server selection display area I15, the server ID of the distributed FS server 2 that is the migration destination is displayed. Here, the displayed server ID of the distributed FS server 2 that is the migration destination is, for example, a server ID selected by the manager in a list box.

In the current load display area I60, the current load of the distributed FS server 2 (before the configuration change) is displayed. The displayed load is calculated by, for example, the rebalancing control program P22. In the post-change load display area I70, the estimate of the load of each distributed FS server 2 when a change to the configuration shown in the configuration change display area I10 is made is displayed. The displayed estimate of the load is calculated by, for example, the rebalancing control program P22. With the post-change load display area I70, the manager can easily and appropriately grasp the state of the load of each distributed FS server 2 after the configuration change.

The apply button I80 receives an instruction to make the configuration change (rebalance) set in the configuration change display area I10. Once the apply button I80 is pressed, the rebalancing control program P22 executes the rebalancing processing illustrated in FIG. 18 such that a change to the configuration illustrated in the configuration change display area I10 is made. The cancel button I90 receives an instruction to cancel the configuration change (rebalancing). Once the cancel button I90 is pressed, the rebalancing control program P22 cancels the rebalancing.

### Second Embodiment

Next, an outline of a distributed storage system 0A as an example of a computer system according to a second embodiment will be described.

The distributed storage system 0A is a distributed object storage using a pseudo random number data arrangement algorithm. Here, the pseudo random number data arrangement algorithm is an algorithm for arranging data in an unbiased manner by using a hash value of the data, and examples of such an algorithm include controlled replication under scalable-hashing (CRUSH). In addition, Ceph using CRUSH is an example of the object storage using the pseudo random number data arrangement algorithm.

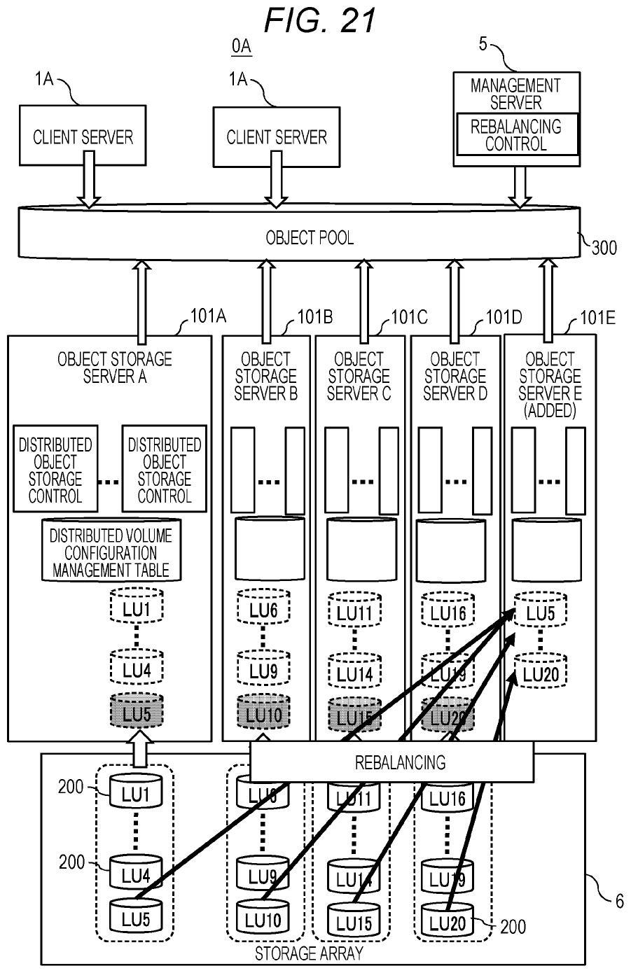

In the distributed storage system 0A, a distributed object storage is configured by a plurality of object storage servers 101, and each object storage server 101 uses a shared storage (storage array 6). In the distributed storage system 0A, a plurality of LUs 200 (which are also referred to as storage devices in the present embodiment, and is an example of logical unit areas) are created, and an object pool 300 (see FIG. 21: an example of a shared storage area) is configured by a plurality of LUs 200. Similarly to the first embodiment, the distributed storage system 0A realizes high-speed rebalancing in which the LU 200 is migrated between distributed servers when increasing or decreasing the number of distributed servers (object storage servers 101) such that there is no data transfer via a network.

FIG. 21 is a diagram illustrating an outline of processing executed by the distributed storage system according to the second embodiment. Note that components similar to those of the distributed storage system according to the first embodiment are denoted by the same reference signs, and an overlapping description will be omitted. FIG. 21 illustrates an outline of rebalancing processing at the time of increasing the number of servers in the distributed storage system 0A.

The distributed storage system 0A includes the object storage server 101 (101A to 101E) instead of the distributed FS server 2 in the distributed storage system 0, and includes the object pool 300 instead of the distributed volume 100. The distributed storage system 0A provides, to the client server 1A, the object pool 300 for storing user data. The object pool 300 includes a plurality of LUs 200 provided to s plurality of object storage servers 110. In the example of FIG. 21, the object pool 300 includes the LUs 200 provided to one or more object storage servers 101 including the object storage server 101A (server A).

The user data stored in the distributed storage system 0A and the object pool 300 is stored, for example, in units of objects (an example of a data unit). The distributed storage system 0A uses the pseudo random number data arrangement algorithm to uniformly distribute (referred to as uniform distribution) the objects among the object storage servers 101.

The object storage server 101 stores the user data in the LU 200 with fine granularity created in the storage array 6. A management server 5 changes the object storage server 101 to which the LU 200 is allocated at the time of rebalancing. At this time, the management server 5 changes a server (a server in charge) in charge of the LU in configuration information (LU allocation management table T7 (see FIG. 13)) of the LU configuring the object pool 300, such that each LU before and after the rebalancing is not changed. As a result, data migration via a network becomes unnecessary, and high-speed data rebalancing can be realized.

FIG. 21 illustrates an outline of the rebalancing processing of rebalancing data of the object pool 300 configured by the LUs 200 (LU 1 to LU 20) managed by the object storage servers 101A to 101D in a case where an object storage server 101E (object storage server E) is added to the distributed storage system 0A including the object storage servers 101A to 101D.

In a case where the object storage server 101E is added, the distributed storage system 0A reallocates, to the object storage server 101E, some LUs 200 (LU 5, LU 10, LU 15, and LU 20) of the LUs 200 (LU 1 to LU 20) allocated to the object storage servers 101A to 101D. At this time, the configuration of the LU in the object pool 300 is not changed, and each LU 200 is not changed. In the distributed storage system 0A, after the reallocation to the object storage server 101E, a distributed object storage control program P41 notifies the client server 1A of data arrangement after the reallocation, and switches data access from the client server 1A to the object storage server 101 corresponding to the data arrangement after the rebalancing. As a result, the distributed storage system 0A can realize data rebalancing to the added object storage server 101E without involving network transfer for data migration between the object storage servers 101.

As described above, in the distributed storage system 0A according to the second embodiment, the object pool 300 is created with a large number (for example, the number is larger than the number of object storage servers 101) of LUs 200 in the storage array 6, and when the configuration of the object storage server 101 is changed, the LUs 200 are reallocated between the object storage servers 101, such that data migration processing via the network is unnecessary. As a result, a time required for the data rebalancing processing can be significantly reduced. A distributed file system that provides, to the client server 1A, the object pool 300 which is a logical storage area is configured.

The configuration of the management server 5 is basically similar to the configuration of the management server 5 illustrated in FIG. 9. In addition, the configuration of the storage array 6 is basically similar to the configuration of the storage array 6 of FIG. 6. Note that the field of the LU ID in the tables of the management server 5 and the storage array 6 is a field in which an ID of the storage device (storage device ID) is stored.

Next, a configuration of the object storage server 101 will be described.

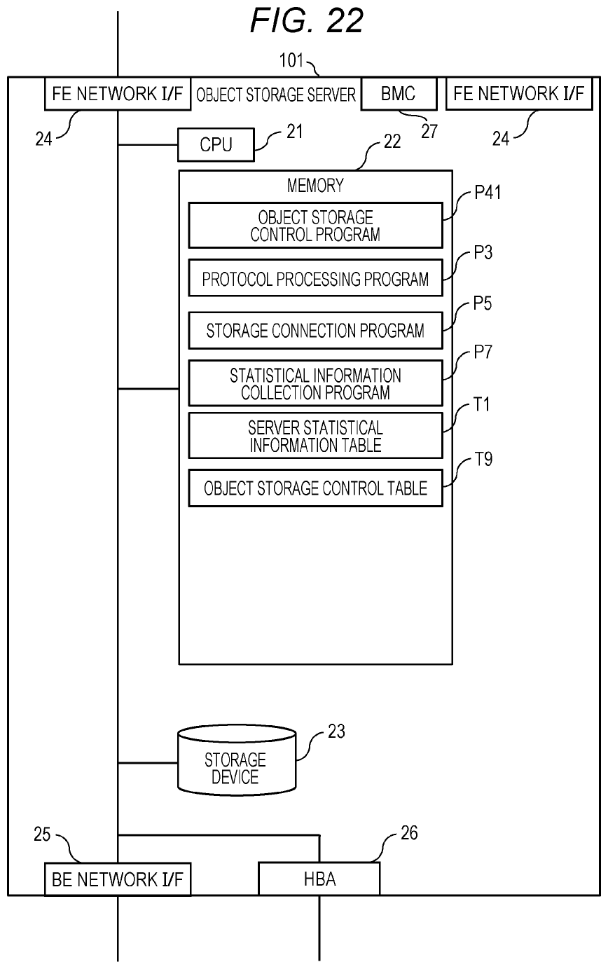

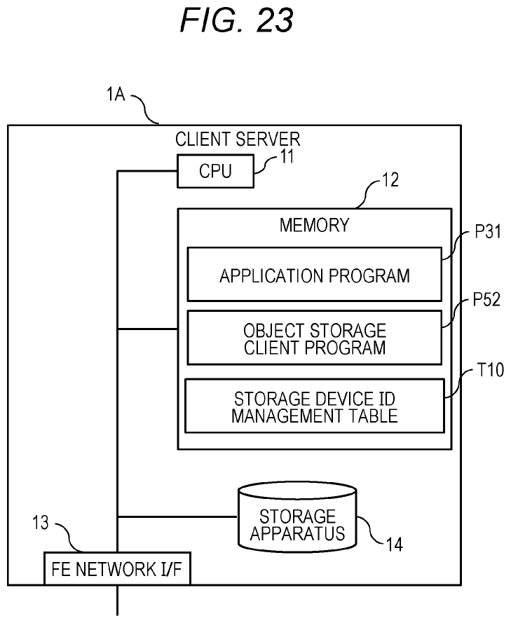

FIG. 22 is a configuration diagram of the object storage server 101 according to the second embodiment. Note that components similar to the distributed FS servers 2 of FIG. 3 are denoted by the same reference signs, and an overlapping description may be omitted.

The object storage server 101 configures an object storage that provides the object pool 300, which is a logical storage area, to the client server 1A together with another object storage server 101.

A memory 22 of the object storage server 101 stores the object storage control program P41 instead of the distributed FS control program P1, and stores an object storage control table T9 instead of the distributed volume configuration management table T0.

The object storage control program P41 cooperates with another object storage server 101 to provide the object pool 300 to the client server 1A.

The object storage control table T9 stores control information of the object storage. An entry of the object storage control table T9 includes a field of a storage pool ID instead of the distributed volume ID C1 in the entry of the distributed volume configuration management table T0 illustrated in FIG. 4. In the field of the storage pool ID, an identifier (storage pool ID) for identifying the storage pool 300 is stored.

Next, a configuration of the client server 1A according to the second embodiment will be described. Note that components similar to those of the client server 1 illustrated in FIG. 14 are denoted by the same reference signs, and an overlapping description may be omitted.

A memory 12 of the client server 1A stores an object storage client program P52 instead of the distributed FS client program P32. In addition, the memory 12 stores a storage device ID management table T10 instead of the hash management table T8.

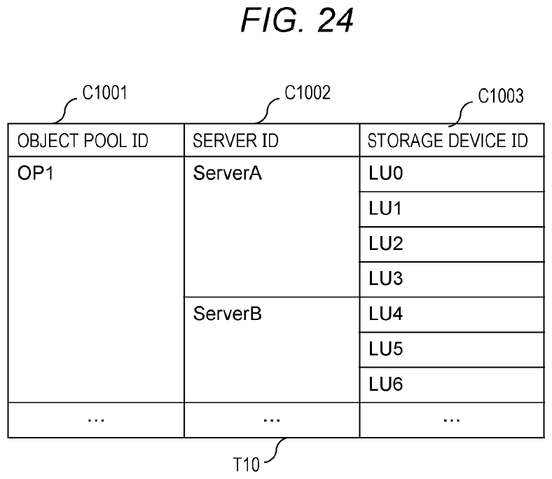

The object storage client program P52 performs a control for connection to the object pool 300. The storage device ID management table T10 is a table for managing an ID (storage device ID) of a storage device (LU 200) necessary for accessing the object pool 300. Details of the storage device ID management table T10 will be described later with reference to FIG. 24.

Next, the configuration of the storage device ID management table T10 will be described in detail.

FIG. 24 is a configuration diagram of the storage device ID management table according to the second embodiment.

The storage device ID management table T10 manages the storage device ID for the object storage client program P52 on the client server 1A to access the object managed by the object storage server 101. The storage device ID management table T10 includes fields including an object pool ID C1001, a server ID C1002, and a storage device ID C1003.

The object pool ID C1001 stores the ID of the object pool 300 (object pool ID). The server ID C1002 stores an identifier (server ID) of the object storage server 101 that stores the object of the object pool 300 corresponding to the entry. The server ID C1002 stores server IDs corresponding to all the object storage servers 101 that manage data of the object pool 300. The storage device ID C1003 stores an ID (storage device ID) of the storage device configuring the object pool 300. The storage device ID C1003 stores storage device IDs of all the storage devices configuring the object pool 300 corresponding to the entry.

An outline of data storage processing in the distributed storage system 0A according to the second embodiment will be described.

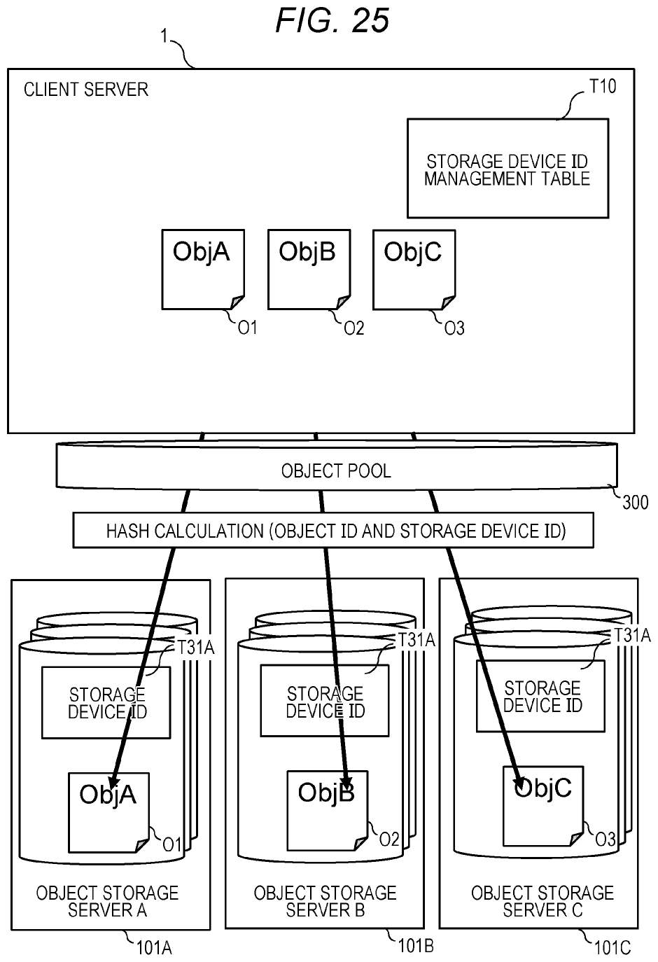

FIG. 25 is a diagram illustrating the outline of the data storage processing in the distributed storage system 0A according to the second embodiment.

FIG. 25 illustrates the outline of the processing in a case where the client server 1A stores objects O1 to O3 (ObjA to ObjC) in the object pool 300 configured by the object storage servers 101A to 101C.

In the client server 1A, when storing a storage target object in the object pool 300, the object storage client program P52 of the client server 1A calculates a score for each storage device by using the following Equation (3).

Score=HASH (object ID and storage Device ID) (3)

Here, HASH is a hash function using a binary value as an argument, and is a function that can be used for the pseudo random number data arrangement algorithm.

Next, the object storage client program P52 stores the storage target object in a storage device (corresponding to the LU 200) having the highest calculated score among the storage devices. Here, since the HASH can be used to calculate a value stochastically uniformly distributed with respect to the argument, the loads and the capacities can be uniformly distributed among the storage devices.

In the distributed storage system 0A according to the second embodiment, pieces of processing (FIGS. 17 to 19) similar to those of the distributed processing system 0 according to the first embodiment described above are executed. Note that, in each processing, the distributed FS control program P1 may be read as the object storage control program P41, the distributed volume configuration management table T0 may be read as the object storage control table T9, the distributed FS client program P32 may be read as the object storage client program P52, the hash management table T8 may be read as the storage device ID management table T10, the distributed FS server 2 may be read as the object storage server 101, the distributed volume 100 may be read as the object pool 300, and the LU ID may be read as the storage device ID.

Hereinabove, the embodiments of the present invention have been described. The above-described embodiments have been described in detail in order to describe the present invention in an easy-to-understand manner, and the present invention is not necessarily limited to those having all the configurations described. A part of a configuration of an embodiment can be replaced with a configuration of another embodiment, and a configuration of an embodiment can be added with a configuration of another embodiment. In addition, a part of the configuration of each embodiment can be added with another configuration, can be deleted, and can be replaced with another configuration. The configurations in the drawings indicate those that are considered necessary for explanation, and do not necessarily indicate all the configurations in a product.

In addition, in the embodiments, a configuration in which a physical server is used as each server has been described. However, the present invention is not limited thereto, and is also applicable to a cloud computing environment using a virtual machine. The cloud computing environment has a configuration in which virtual machines/containers are operated on a system/hardware configuration abstracted by a cloud provider. In this case, the server described in the embodiments can be implemented by a virtual machine/container, and the storage array 6 can be implemented by a block storage service provided by the cloud provider.

What is claimed is:

1. A distributed storage system comprising:
a plurality of distributed servers;
a shared storage area accessible by the plurality of distributed servers; and
a management apparatus, wherein
the shared storage area is configured by a plurality of logical unit areas,
the distributed server that manages each of the logical unit areas is determined,
the logical unit area that stores a data unit is determined based on a hash value for the data unit,
the distributed server that manages the determined logical unit area executes I/O processing on the data unit of the shared storage area, and
when changing the distributed server that manages the logical unit area, a processor of the management apparatus reflects, in the distributed server, a correspondence relationship between the logical unit area after the change and the distributed server that manages the logical unit area.

2. The distributed storage system according to claim 1, wherein the processor generates the shared storage area so that the shared storage area is configured by the logical unit areas larger in number than the distributed servers of the distributed storage system.

3. The distributed storage system according to claim 2, wherein in a case where a configuration of the distributed server of the distributed storage system is changed, the processor changes the distributed server that manages some logical unit areas in the shared storage area so that the numbers of logical unit areas managed by the respective distributed servers are equalized without changing the number of the logical unit areas in the shared storage area.

4. The distributed storage system according to claim 2, wherein the processor calculates a maximum number of servers in the shared storage area, the maximum number of servers being a maximum number of distributed servers with which a predetermined operation rate or more is realizable, and the processor generates the shared storage area configured by the logical unit areas whose number is equal to or smaller than the maximum number of servers.

5. The distributed storage system according to claim 4, wherein the processor calculates the maximum number of servers by estimating an operation rate based on a mean time to failure of the distributed server that manages the logical unit area of the shared storage area.

6. The distributed storage system according to claim 4, wherein the processor generates the shared storage area configured by the logical unit areas whose number is the same as the maximum number of servers.

7. The distributed storage system according to claim 1, wherein
the distributed storage system comprises a plurality of shared storage areas, and
the processor adjusts the distributed server that manages the logical unit area so that loads of the respective distributed servers of the distributed storage system are equalized.

8. The distributed storage system according to claim 1, wherein the distributed server notifies a client server that uses data for the shared storage area of the correspondence relationship between the logical unit area and the distributed server that manages the logical unit area.

9. A management method executed by a distributed storage system including a plurality of distributed servers, a shared storage area accessible by the plurality of distributed servers, and a management apparatus, wherein
the shared storage area is configured by a plurality of logical unit areas,
the distributed server that manages each of the logical unit areas is determined,
the logical unit area that stores a data unit is determined based on a hash value for the data unit,
the distributed server that manages the determined logical unit area executes I/O processing on the data unit of the shared storage area, and
when changing the distributed server that manages the logical unit area, the management apparatus reflects, in the distributed server, a correspondence relationship between the logical unit area after the change and the distributed server that manages the logical unit area.
